(19) United States
(12) Patent Application Publication
(10) Pub. No.: US 2002/0124569 A1
(43) Pub. Date: Sep. 12, 2002

(54) Bimetallic high temperature recuperator

(76) Inventors: William D. Treece, La Mesa, CA (US); Yungmo Kang Korean, La Canada Flintridge, CA (US); Robert McKiernan, Westlake Village, CA (US)

Correspondence Address: IRELL & MANELLA LLP, 1800 Avenue of the Stars, Suite 900, Los Angeles, CA, 90067, US

(21) Appl. No.: 10/044,496

(22) Filed: Jan. 10, 2002

Related U.S. Application Data
(60) Provisional application No. 60/260,964, filed on Jan. 10, 2001.

(51) Int. Cl. F02C 7/10

(52) U.S. Cl. 60/772; 60/39.511

(57) ABSTRACT

A turbine engine includes a turbine driven by hot gas, a compressor rotating with the turbine to generate compressed air, an annular combustor coaxial with the turbine to combust fuel and compressed air to generate the hot gas, and an annular recuperator to recover heat from the turbine exhaust gas and heat the compressed air for combustion. The annular recuperator surrounds the turbine and includes two contiguous parts made from two materials having different thermal properties and joined to one another to form a single annular structure. One recuperator part is formed from a high-temperature material having a high thermal limit for exposure to high-temperature turbine exhaust gas, and the other recuperator part is formed from a material having a lower thermal limit than the high-temperature material for exposure to reduced-temperature turbine exhaust gas.

### RELATED APPLICATIONS

This patent application claims the priority of provisional patent application Ser. No. 60/260,964, filed Jan. 10, 2001.

### BACKGROUND OF THE INVENTION

A turbogenerator generally includes, a turbine, an electrical generator, a compressor, a recuperator, and a combustor. The compressor impeller, the turbine impeller, and the generator rotor are mounted on a common shaft that is supported by journal and thrust bearings. Air is continuously compressed in the compressor, mixed with fuel, and injected into the combustor through fuel injectors. The air/fuel mixture is ignited in the combustor, such as by electrical spark, hot surface ignition, or catalyst. The heat energy released by the combustion reaction expands the combustion gas, which then impinges upon and rotates the turbine impeller and common shaft, thereby converting the heat energy released by the combustion reaction into rotary mechanical energy for driving the compressor impeller and the electrical generator rotor. After the combustion gas has passed through the turbine, it is typically vented to the atmosphere as exhaust gas.

To increase overall system efficiency, the turbine engine is often recuperated, that is, a heat exchanger (recuperator) is utilized to recover waste heat from the exhaust gas prior to venting it to the atmosphere and to transfer the recovered heat to the compressed air prior to injection into the combustor. Employing heat recuperation can significantly reduce the amount of fuel required to sustain the combustion process in the combustor.

The efficiency of a turbogenerator system increases at high temperatures. To withstand high temperatures, the recuperator must be fabricated from materials having high thermal limits. Such materials are generally expensive and therefore recuperators employing such materials may be impractical from an economic point of view. Therefore, what is now needed is a turbine engine with an improved recuperator that withstands high temperatures and that may be fabricated economically.

### SUMMARY OF THE INVENTION

In a first aspect, the present invention provides a turbine engine comprising a turbine disposed for rotation about an axis; a compressor coupled to the turbine for rotating therewith to generate compressed air; an annular combustor disposed coaxially with the turbine for combusting fuel and the compressed air to generate hot gas for rotating the turbine; and a plurality of cold cells annularly disposed about the turbine for conducting the compressed air from the compressor to the combustor, at least one of the cold cells including a hot part in fluid communication with the combustor and formed from a first material having a first temperature limit, and further including a cold part joined to the hot part and in fluid communication with the compressor, the cold part formed from a second material having a second temperature limit lower than the first temperature limit.

In another aspect, the invention provides a method of operating a turbine engine, comprising driving a turbine rotationally with hot gas; coupling a compressor to the turbine to rotate therewith and generate compressed air; combusting fuel and the compressed air in an annular combustor disposed coaxially with the turbine to generate the hot gas for driving the turbine; and conducting the compressed air from the compressor to the combustor through a plurality of cold cells annularly disposed around the turbine, at least one of the cold cells including a hot part in fluid communication with the combustor and formed from a first material having a first temperature limit, and further including a cold part joined to the hot part and in fluid communication with the compressor, the cold part formed from a second material having a second temperature limit lower than the first temperature limit.

In a further aspect, the cold part is connected to the hot part to form a continuous flow path for the compressed air from at least one cold inlet in the cold part in fluid communication with the compressor to at least one hot outlet in the hot part in fluid communication with the combustor. The plurality of cold cells may be disposed to define a plurality of hot cells therebetween for conducting exhaust gas from a turbine outlet to an exhaust vent to transfer thermal energy from exhaust gas flowing in the hot cells to compressed air flowing in the cold cells.

In a still further aspect, the first material may comprise a single crystal metallic microstructure, or a superalloy comprising at least one of nickel and cobalt. Additionally, the second material may comprise an equiaxed metallic microstructure or stainless steel. The first material may also comprises a low-temperature material with a layer of high-temperature material deposited thereupon, such as a sintered ceramic. The first material may additionally comprise a layer of catalytic material deposited on a surface of the hot part in contact with the exhaust gas.

In another aspect, the hot part may be joined to the cold part using any single one or combination of plasma welding, ultrasonic welding, friction welding, fusion welding, forge welding and laser beam welding.

### BRIEF DESCRIPTION OF THE DRAWINGS

FIG. 1A is a perspective view, partially in section, of an integrated turbogenerator system;

FIG. 1B is a magnified perspective view, partially in section, of the motor/generator portion of the integrated turbogenerator of FIG. 1A;

FIG. 1C is an end view, from the motor/generator end, of the integrated turbogenerator of FIG. 1A;

FIG. 1D is a magnified perspective view, partially in section, of the combustor-turbine exhaust portion of the integrated turbogenerator of FIG. 1A;

FIG. 1E is a magnified perspective view, partially in section, of the compressor-turbine portion of the integrated turbogenerator of FIG. 1A;

FIG. 2 is a block diagram schematic of a turbogenerator system as shown in FIGS. 1A-E including a power controller having decoupled rotor speed, operating temperature, and DC bus voltage control loops;

FIG. 3 is a diagram showing in cross-section the spacing and placement of cold and hot cells in the annular recuperator that may be used in the turbogenerator system of FIGS. 1A-E;

FIG. 4 is an enlarged view of the cold and hot cells in the annular recuperator of FIG. 3;

FIG. 5 is a perspective view showing the joining of two heat transfer plates to form a cold cell as depicted in FIG. 4;

FIG. 6 is a front view of a heat transfer plate of a cold cell depicted in FIG. 3 showing flow paths of compressed air and turbine exhaust gas;

FIG. 7 illustrates joining of hot and cold parts of a heat transfer plate according to the invention for use with the turbogenerator system of FIGS. 1A-E; and

FIG. 8 illustrates welding of hot and cold parts of a heat transfer plate using a laser beam in accordance with the invention.

### DETAILED DESCRIPTION OF THE INVENTION

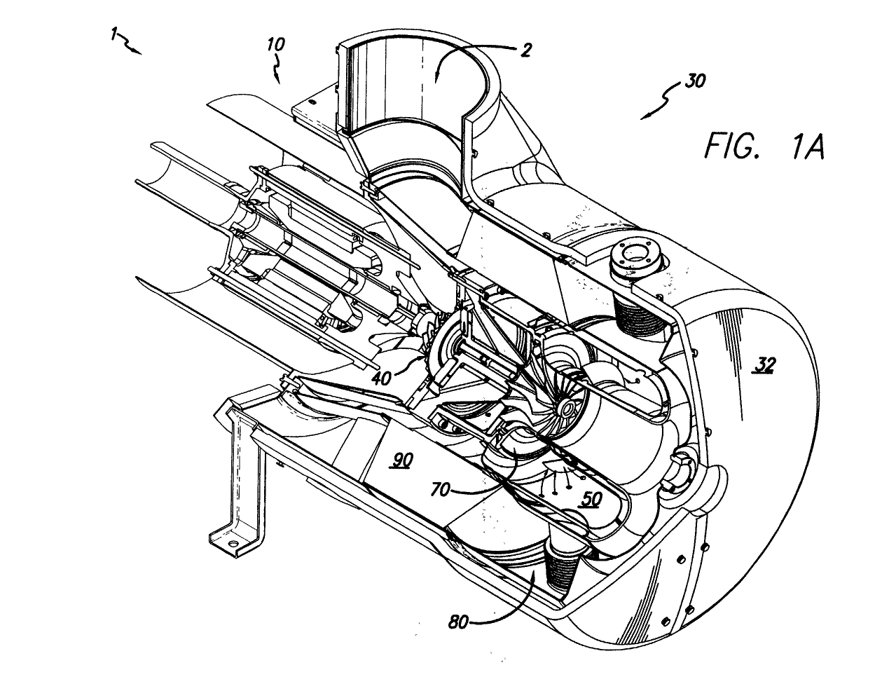

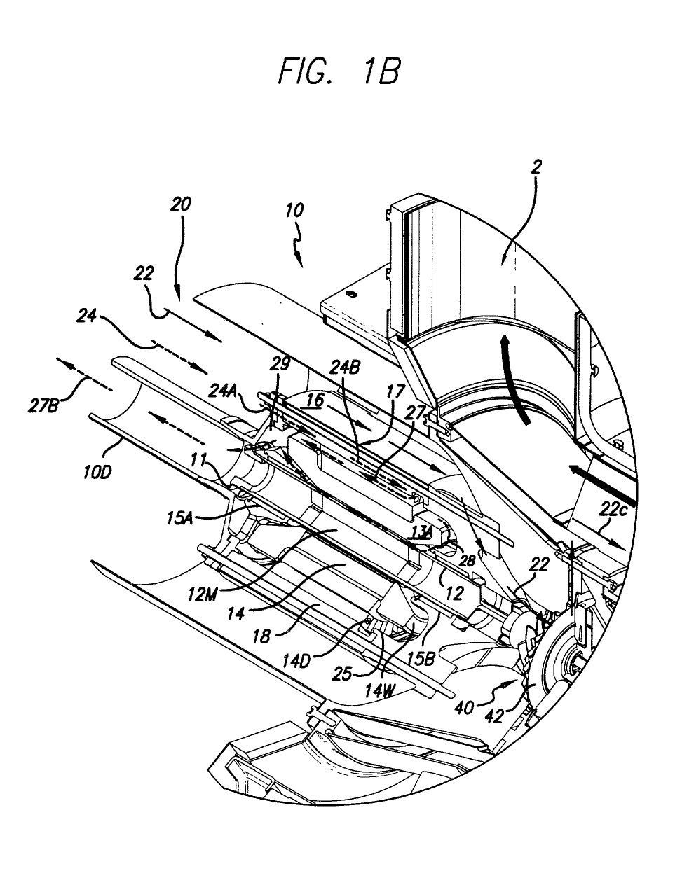

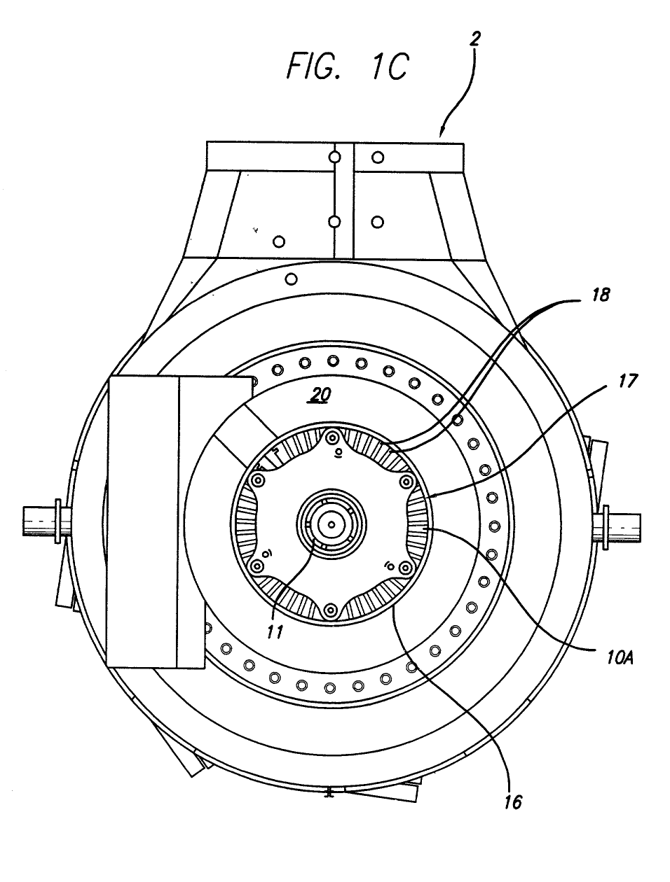

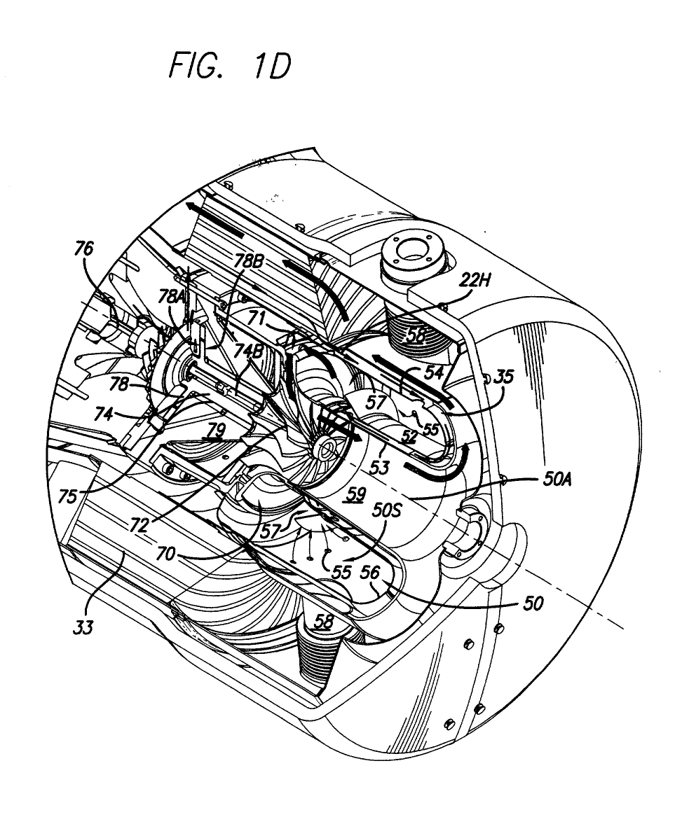

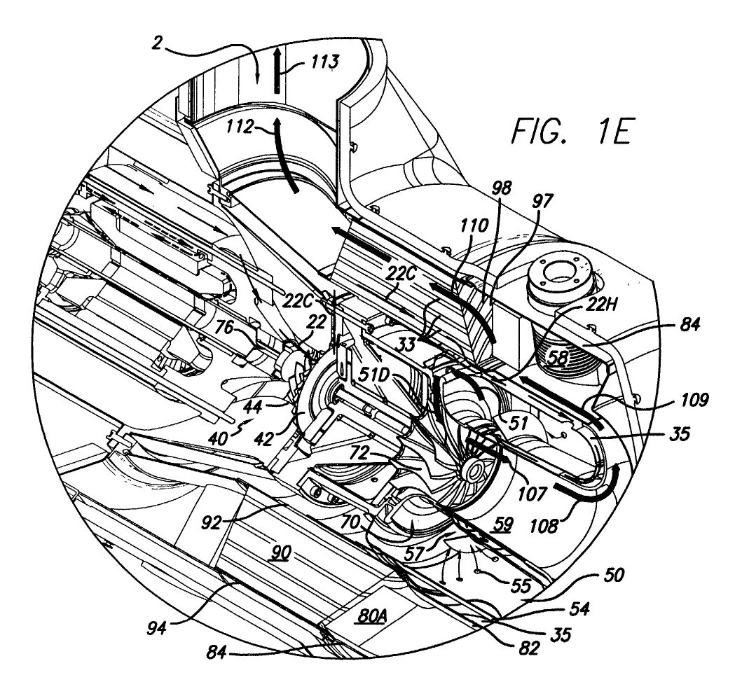

With reference to FIG. 1A, an integrated turbogenerator 1 according to the present disclosure generally includes motor/generator section 10 and compressor-turbine section 30. Compressor-turbine section 30 forms the engine of turbogenerator 1 and includes exterior can 32, compressor 40, combustor 50 and turbine 70. A recuperator 90 may be optionally included.

Referring now to FIG. 1B and FIG. 1C, in a currently preferred embodiment of the present disclosure, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

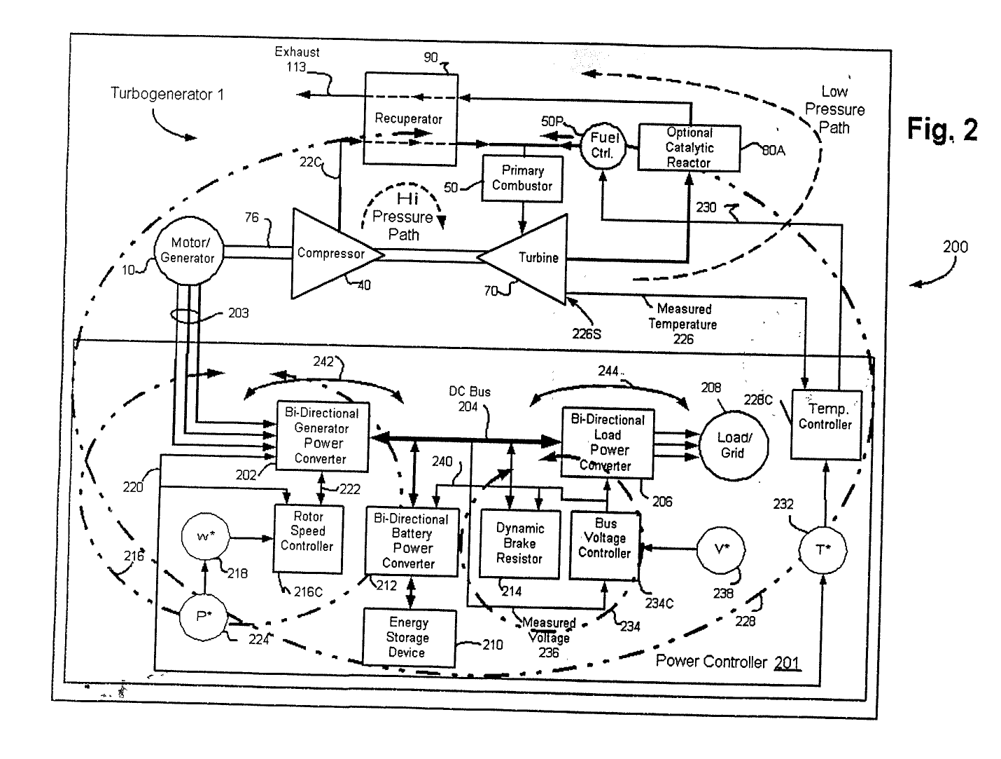

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 50A. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 74 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 97 of recuperator 90, as indicated by gas flow arrows 108 and 109 respectively.

In an alternate embodiment of the present disclosure, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

The integrated turbogenerator disclosed above is exemplary. Several alternative structural embodiments are disclosed below. In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In still another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

An integrated turbogenerator is a turbogenerator in which the turbine, compressor, and generator are all constrained to rotate based upon rotation of the shaft to which the turbine is connected. The methods and apparatus disclosed herein are preferably but not necessarily used in connection with a turbogenerator, and preferably but not necessarily used in connection with an integrated turbogenerator.

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

Referring again to FIG. 1E, recuperator 90 receives, channels, and transfers heat from hot fluid stream 110 (formed by the turbine exhaust gas) to cold fluid stream 22C (formed by the compressed air from the compressor). Ideally, recuperator 90 maximizes the thermal intermixing of the two streams while keeping the streams physically separate and also minimizing the flow resistance encountered by the two streams. Recuperator 90 may include a plurality of low temperature, high pressure “cold” cells disposed adjacent to high temperature, low pressure “hot” cells in an alternating pattern repeated over the entire diameter of the recuperator.

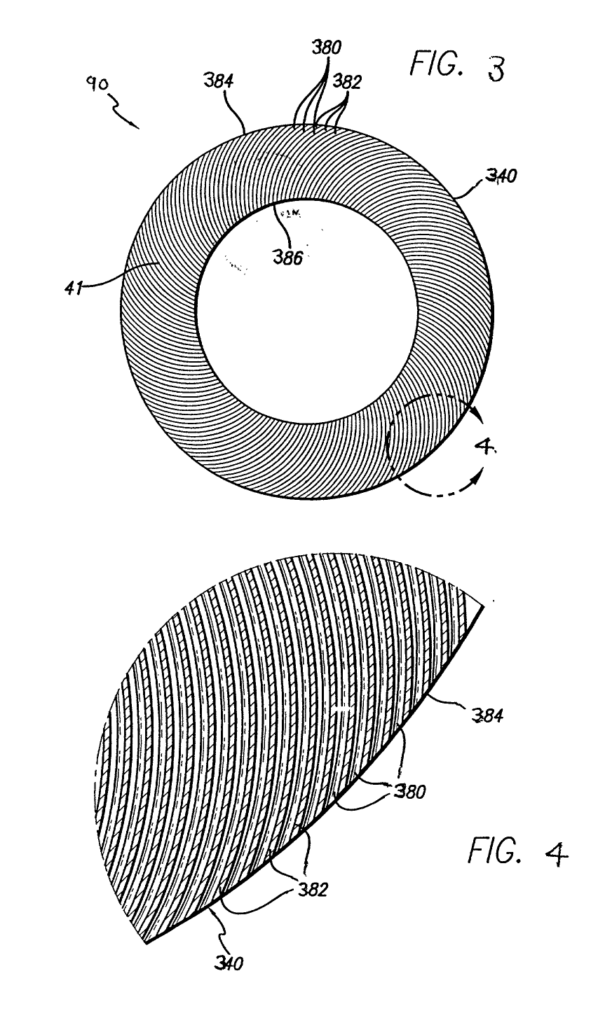

Referring to FIG. 3 and FIG. 4, recuperator core 41 is shown in greater detail as formed of alternating cold cells 380 and hot cells 382 disposed in an annular pattern. Hot cells 382 may be flow channels defined by neighboring cold cells 380, outer diameter 384 as defined by annular housing 340 of annular recuperator 90, and inner diameter 386. Cold cells 380 may be formed with a generally rectangular cross section and thereafter may be molded into a generally arcuate configuration. This arcuate configuration allows both cold and hot cells to maintain a relatively constant cross section along their radial length. The upper edges of cold cells 380 abut annular housing 340 but are typically not connected to the housing so as to be able to move with respect to the housing as may be necessitated by thermal expansion and contraction.

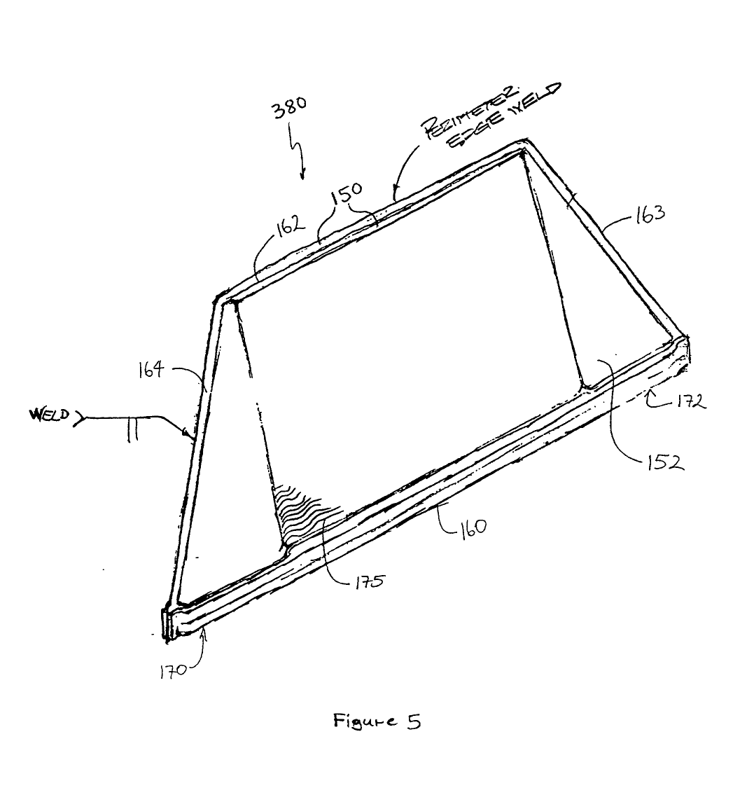

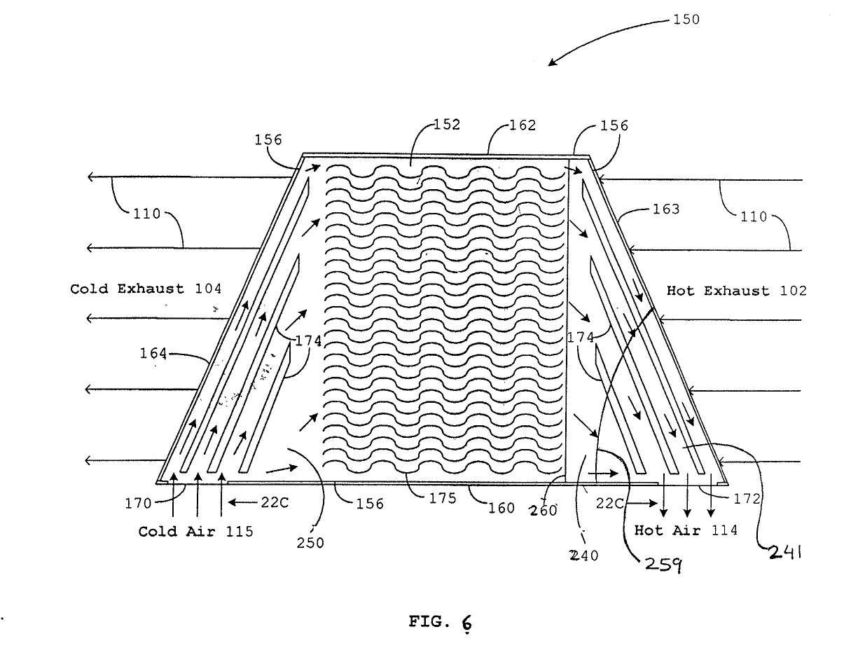

With reference now to FIG. 5 and FIG. 6, a typical high-pressure cold cell 380 is shown to include two heat transfer plates 150 spaced apart from each other. The plate 150 may have a heat transfer surface 152 and a lip 156 may extend along the entire perimeter of the heat transfer surface 152. The two heat transfer surfaces 152 of a cold cell 380 may be spaced apart by having lip 156 of one heat transfer surface 152 abutting lip 156 of other heat transfer surface 152. The cold cell 380 may be formed by welding lips 156 of the two heat transfer plates 150 along the edge of the cold cell 380. The cold cell 380 has a generally trapezoidal shape defined by a longer inner edge 160, a shorter outer edge 162, and angled edges 163 and 164 extending between the inner and outer edge. The lip 156 is interrupted at the two opposite ends of the inner edge 160 to form air inlet 170 and air outlet 172.

As described previously, cool compressed air enters the air inlet 170, is heated while flowing along the axial length of the cell 150, and exits as hot air through outlet 172. To encourage the even distribution of air flow, flow channels are defined within the cell 380, including directional channels 174 and convolute channels 175. The purpose of directional channels 174 is to radially distribute air flow between inner edge 160 and outer edge 162. Convolute channels 175 are designed to maximize thermal intermixing of compressed air 22C with counter-flowing exhaust gas 110, and extend from both sides of each heat transfer surface. Angled edges 163 and 164 serve to direct the flow of air and aid in maintaining relatively constant velocity throughout the cell.

As may be appreciated from FIG. 5 and FIG. 6 and the previous description, the part of cell 380 and heat transfer plates 150 bordered by angled edge 163 is in contact with hot exhaust gas 102 from the turbine and relatively hot compressed air 114, whereas the part of the cell 380 bordered by angled edge 164 is in contact with cold exhaust gas 104 (that has transferred a significant amount of its heat energy to counterflowing cold compressed air 115) and cold compressed air 115. Thus, there is a significant difference in the temperature of the cell 380 and heat transfer plates 150 near cold air inlet 170 and the temperature near hot air outlet 172. Hot exhaust gas 102 is generally limited in conventional stainless steel recuperators to a temperature of no more than 1200° F. due to the thermal limit of the stainless steel. However, the exhaust gas temperature may decrease significantly along the axis of the recuperator from the hot exhaust side to the cold exhaust side, and thus only the recuperator material near the hot exhaust side would typically experience temperatures near the thermal limit.

An embodiment of the invention takes advantage of this decreasing temperature profile along the length of the recuperator and provides a recuperator fabricated from different materials having different thermal limits at various axial locations along the axial length of the recuperator. The materials may be selected in accordance with a predicted temperature profile for the recuperator, such as the predicted temperature profile for full-load operation of the turbogenerator at the highest rated TET. Generally, a high-temperature material, that is, a material having a high thermal limit, is used to fabricate the part of cold cell 380 near the inlet of hot exhaust 102 , and a lower-cost low-temperature material having a lower thermal limit is used to fabricate the part of cold cell 380 near the outlet of cold exhaust 104. Controller 200 may be used to control the TET not to exceed a predetermined temperature and ensure the recuperator operates within allowable temperature limits.

Thus, and with continued reference to FIG. 6, in one embodiment of the invention each heat transfer plate 150 of cold cell 380 has high-temperature part 240 formed from a high-temperature material, and low-temperature part 250 formed from a low-temperature material. The high-temperature part may be joined to the low-temperature part along seam 260 by any practicable method as known to those skilled in the art. The joining of the high-temperature and the low-temperature parts provides a continuous flow path for the exhaust gas from hot exhaust 102 to cold exhaust 104. The seam 260 may be located at an axially displaced location sufficiently removed from the hot exhaust inlet to ensure that it will not experience temperatures in excess of the low-temperature material thermal limit. The portion of the heat transfer plate 150 that experiences high temperatures may be limited to a reduced area near hot exhaust 102 defined by a curvilinear boundary shown in FIG. 6 as line 259. However, for ease of fabrication, a generally straight seam 260 may be provided. The size of hot part 240 may be greater than that required for normal operations to allow for operational temperature fluctuations.

The high-temperature material may be any material known to those skilled in the art to possess the required physical properties, and in one embodiment include nickel and/or cobalt based superalloys. In another embodiment, the high-temperature material may have a single crystal metallic microstructure. A single crystal is a monocrystalline structure in which the casting is one single grain (crystal). The low-temperature material may have an equiaxed metallic microstructure. An equiaxed microstructure is a polycrystalline structure in which all of the grains (crystals) in a casting have approximately the same dimensions in all directions.

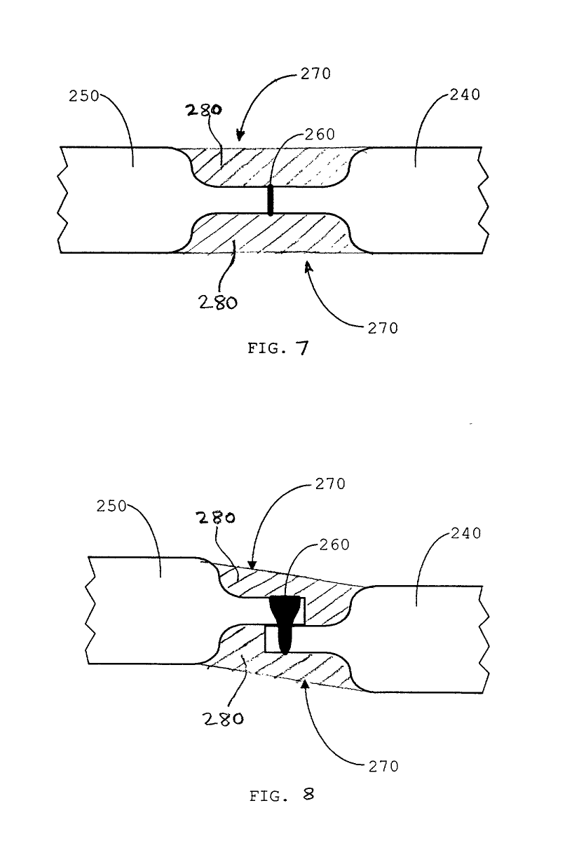

Methods for forming the seam may include plasma welding, ultrasonic welding, friction welding, fusion welding, forge welding and/or laser beam welding. As shown in FIG. 7, the actual joint at which the seam 260 is formed may be fabricated by adjoining the edge of low-temperature part 250 to the edge of high-temperature part 240 and welding the edges together. In the embodiment of FIG. 7, the adjoining edges have reduced thickness to aid the welding process by presenting reduced areas to adjoin and weld together. This configuration would result in a channel 270 extending the length of the seam 260 on both sides of the heat transfer surface 152. The channel 270 may be filled with a suitably high thermal-limit material 280 to preclude any pressure drop in the gases flowing through the cold and hot cells of the recuperator.

With reference to FIG. 8, in another embodiment, the seam 260 would be formed by overlaying the edge of one of the parts (in FIG. 8, low-temperature part 250) over the edge of the other part (in FIG. 8, high-temperature part 240) and ‘spiking’ seam 260 through both edges by laser beam welding or a similar method. The width and depth of the spike would be dependent upon the power deposited by the weld and the period of time over which the weld is applied, and could therefore be generally formed in a desired shape. Thus, the spike (i.e. mass of low-temperature and high-temperature material melted together by the heat applied by the weld) may extend completely through both the low-temperature part 250 and the high-temperature part 240 as shown in FIG. 8, or alternatively may extend only partially through the bottom part (e.g. the high-temperature part in FIG. 8).

Seam 260 may be formed on each individual heat transfer plate 150 after low-temperature part 250 and high-temperature part 240 have been formed into the desired configuration. Alternatively, the seam may be formed between two continuous sheets of low-temperature and high-temperature material, respectively, prior to shaping individual heat transfer plates 150. In yet another embodiment, seam 260 may be formed by forge welding two such continuous sheets of low-temperature and high-temperature material prior to shaping individual heat transfer plates 150. This structure would also result in a channel 270 extending the length of seam 260 on both sides of heat transfer surface 152. Channel 270 may be filled with a suitably high thermal-limit material 280 to preclude any pressure drop in the gases flowing through the cold and hot cells of the recuperator.

Although the embodiments described above focus upon an annular recuperator, those skilled in the art will understand that the invention is equally applicable to any recuperator, including primary surface recuperators, spiral wound recuperators, plate fin recuperators, and box type recuperators. The invention is also not limited to counter-flowing recuperators, but may be applied to recuperators in which the hot and cold streams flow in the same direction. Furthermore, the invention contemplates the use of any type of low- and high-temperature material that offers the requisite characteristics, including thermal limits, cost, ease of fabrication, compatibility with one another, and ability to join together with sufficient strength.

Materials that may be utilized according to the invention include layered materials, e.g. sheets of various materials bonded to each other such as, for example, a low-temperature material with a layer of high-temperature material (e.g. a sintered ceramic) deposited on it. In another embodiment of the invention, high-temperature part 240 may include a layer of catalytic material deposited thereon to react with any unburned fuel or other hydrocarbons present in hot exhaust gas 102, thus providing in essence a secondary catalytic reactor for turbogenerator system 1. Further details of such a secondary catalytic reactor may be found in co-pending and co-owned U.S. patent application Ser. No. 09/933,663 filed on Aug. 22, 2001, entitled “INTEGRATED TURBINE POWER GENERATION SYSTEM HAVING LOW PRESSURE SUPPLEMENTAL CATALYTIC REACTOR” and incorporated herein in its entirety by reference thereto.

Having now described the invention in accordance with the requirements of the patent statutes, those skilled in the art will understand how to make changes and modifications to the embodiments disclosed to meet their specific requirements or conditions. Such changes and modifications may be made without departing from the scope and spirit of the invention, as defined and limited solely by the following claims.

What is claimed is:

1. A turbine engine, comprising:
a turbine disposed for rotation about an axis;
a compressor coupled to the turbine for rotating therewith to generate compressed air;
an annular combustor disposed coaxially with the turbine for combusting fuel and the compressed air to generate hot gas for rotating the turbine; and
a plurality of cold cells annularly disposed about the turbine for conducting the compressed air from the compressor to the combustor, at least one of the cold cells including a hot part in fluid communication with the combustor and formed from a first material having a first temperature limit, and further including a cold part joined to the hot part and in fluid communication with the compressor, the cold part formed from a second material having a second temperature limit lower than the first temperature limit.

2. The turbine engine of claim 1, wherein the cold part is connected to the hot part to form a continuous flow path for the compressed air from at least one cold inlet in the cold part in fluid communication with the compressor to at least one hot outlet in the hot part in fluid communication with the combustor.

3. The turbine engine of claim 2, wherein the plurality of cold cells are disposed to define a plurality of hot cells therebetween for conducting exhaust gas from a turbine outlet to an exhaust vent to transfer thermal energy from exhaust gas flowing in the hot cells to compressed air flowing in the cold cells.

4. The turbine engine of claim 3, wherein the first material comprises a single crystal metallic microstructure.

5. The turbine engine of claim 4, wherein the second material comprises an equiaxed metallic microstructure.

6. The turbine engine of claim 3, wherein the first material comprises a superalloy comprising at least one of nickel and cobalt.

7. The turbine engine of claim 6, wherein the second material comprises stainless steel.

8. The turbine engine of claim 1, wherein the hot part is joined to the cold part using a joining technique comprising at least one of plasma welding, ultrasonic welding, friction welding, fusion welding, forge welding and laser beam welding.

9. The turbine engine of claim 3, wherein the hot part is joined to the cold part using a joining technique comprising at least one of plasma welding, ultrasonic welding, friction welding, fusion welding, forge welding and laser beam welding.

10. The turbine engine of claim 3, wherein the first material comprises a low-temperature material with a layer of high-temperature material deposited thereupon.

11. The turbine engine of claim 10, wherein the layer of high temperature material comprises a sintered ceramic.

12. The turbine engine of claim 3, wherein the first material comprises a layer of catalytic material deposited on a surface of the hot part in contact with the exhaust gas.

13. The turbine engine of claim 3, wherein the hot part is formed with an axial length selected in accordance with a selected temperature for the exhaust gas.

14. A method of operating a turbine engine, comprising:
driving a turbine with hot gas to rotate about an axis;
coupling a compressor to the turbine to rotate therewith and generate compressed air;
combusting fuel and the compressed air in an annular combustor disposed coaxially with the turbine to generate the hot gas for driving the turbine; and
conducting the compressed air from the compressor to the combustor through a plurality of cold cells annularly disposed around the turbine, at least one of the cold cells including a hot part in fluid communication with the combustor and formed from a first material having a first temperature limit, and further including a cold part joined to the hot part and in fluid communication with the compressor, the cold part formed from a second material having a second temperature limit lower than the first temperature limit.

15. The method of claim 14, wherein the cold part is connected to the hot part to form a continuous flow path for the compressed air from at least one cold inlet in the cold part in fluid communication with the compressor to at least one hot outlet in the hot part in fluid communication with the combustor.

16. The method of claim 15, wherein the plurality of cold cells are disposed to define a plurality of hot cells therebetween for conducting exhaust gas from a turbine outlet to an exhaust vent to transfer thermal energy from exhaust gas flowing in the hot cells to compressed air flowing in the cold cells.

17. The method of claim 16, wherein the first material comprises a single crystal metallic microstructure.

18. The method of claim 17, wherein the second material comprises an equiaxed metallic microstructure.

19. The method of claim 16, wherein the first material comprises a superalloy comprising at least one of nickel and cobalt.

20. The method of claim 19, wherein the second material comprises stainless steel.

21. The method of claim 14, wherein the hot part is joined to the cold part using a joining technique comprising at least one of plasma welding, ultrasonic welding, friction welding, fusion welding, forge welding and laser beam welding.

22. The method of claim 16, wherein the hot part is joined to the cold part using a joining technique comprising at least one of plasma welding, ultrasonic welding, friction welding, fusion welding, forge welding and laser beam welding.

23. The method of claim 16, wherein the first material comprises a low-temperature material with a layer of high-temperature material deposited thereupon.

24. The method of claim 23, wherein the layer of high temperature material comprises a sintered ceramic.

25. The method of claim 16, wherein the first material comprises a layer of catalytic material deposited on a surface of the hot part in contact with the exhaust gas.

26. The method of claim 16, wherein the hot part is formed with an axial length selected in accordance with a selected temperature for the exhaust gas.
